(19) United States
(12) Patent Application Publication
(10) Pub. No.: US 2024/0074361 A1
(43) Pub. Date: Mar. 7, 2024

(54) Glaciation of mixed-phase clouds to restore terrestrial and sea ice at high latitudes

(71) Applicant: George Henry Zapalac, Santa Clara, CA (US)

(72) Inventor: George Henry Zapalac, Santa Clara, CA (US)

(21) Appl. No.: 17/902,831

(22) Filed: Sep. 4, 2022

(51) Int. Cl. A01G 15/00

(52) U.S. Cl. CPC A01G 15/00

(57) ABSTRACT

A method is provided to reduce the surface temperature at high latitudes beneath mixed-phase low-level clouds. The clouds are seeded by ice crystals from dry ice pellets or from water droplets sprayed by effervescent nozzles or by injection of silver iodide. The ice crystals convert supercooled liquid water in the clouds into ice crystals by the Wegener-Bergeron-Findeisen process. Ice-only clouds are more transmissive to long wavelength radiation than mixed-phase clouds, thereby allowing more surface long wavelength radiation to escape into space or into higher, colder regions of the atmosphere.

### CROSS-REFERENCE TO RELATED PUBLICATION

This application claims the benefit of a scientific poster presented by the inventor in New Orleans at the American Geophysical Union conference on Dec. 15, 2021. The poster was published online on Dec. 26, 2021: https://www.essoar.org/doi/10.1002/essoar.10509873.1.

### FIELD

Climate change, cloud seeding, geoengineering, sea ice.

### BACKGROUND

The Arctic is warming about 3 times faster than the rest of the planet, and the loss of sea ice accelerates Arctic warming by reducing the Arctic albedo. A warming Arctic destabilizes the jet stream and negatively affects weather patterns at lower latitudes causing heat waves, cold waves, flooding, droughts, and wildfires.¹ As the Arctic tundra melts it damages building and transportation infrastructure and releases methane into the atmosphere, a potent greenhouse gas. An artificial method to cool the Arctic and restore sea and tundra ice would reduce the negative impacts of climate change during the transition period required to implement long-term solutions for reversing climate change such as the deployment of renewable energy and the capture and sequestration of legacy carbon dioxide in the atmosphere.

### SUMMARY

This invention restores terrestrial and sea ice at high latitudes (latitudes greater than 60° N or 60° S) by glaciating low-lying stratus or stratocumulus clouds during the darker months of the year. Cloud glaciation may be accomplished, for example, by seeding clouds with dry ice pellets released from aircraft into the tops of the clouds. In polar regions mixed-phase clouds have a layer of supercooled liquid droplets near the top of the cloud and a more diffuse layer of ice crystals in the lower part of the cloud. The liquid droplet layer absorbs long wavelength (LW, wavelength>4 microns) radiation or heat from the earth's surface, then re-emits part of this radiation back to the surface, warming the surface compared to clear sky or ice-only cloud scenes. If the concentration of ice nucleating particles (INP) is artificially increased by seeding, the cloud will glaciate by the Wegener-Bergeron-Findeisen (WBF) process to create an ice-only cloud that may dissipate thereafter. An ice-only cloud transmits most long wavelength surface radiation to higher, colder regions of the atmosphere or into space, thereby allowing the surface to cool more effectively than beneath a mixed-phase cloud. Clouds also reflect shortwave (SW, wavelength<4 microns) radiation which cools the surface. In the Arctic, clouds exert a net warming on the surface except for two or three weeks during the month of July. On average, Arctic mixed-phase clouds increase the LW forcing at the Arctic surface by 30 W m⁻² during the fall, winter, and spring.²

There are other proposals to cool the Arctic. Stratospheric aerosol injection of SO₂ north of 60° N latitude during spring would reduce SW solar radiative warming of the Arctic during the summer.³ A proposal called Arctic Ice Management (AIM) would pump seawater onto sea ice during the winter so that it freezes, thickening the ice to prevent it from melting away entirely during the summer.⁴ Applying a thin layer of hollow glass microspheres (65 um diameter) over newly formed sea ice would increase the ice albedo from 30% to 80% so that new ice is less likely to melt during the summer.⁵ Marine Cloud Brightening⁶ (MCB) has been proposed to brighten Arctic clouds during the summer to enhance the cooling from the reflection of SW radiation.⁷ With the exception of AIM, all of these methods cool the Arctic by reflecting SW solar radiation during the summer. Hence each of these methods, including AIM, is complementary to this invention, which reduces the downwelling of LW radiation during the fall, winter, and spring.

This invention bears some resemblance to the concept of cirrus cloud thinning,⁸ where cirrus clouds are seeded to allow surface LW radiation to escape into space. However, this invention is distinguished from cirrus cloud thinning in many ways. Cirrus clouds are high-altitude, ice-only clouds, whereas this application targets low-altitude, mixed-phase clouds. Cirrus clouds cannot be glaciated because they are already ice-only clouds, whereas this invention specifically targets clouds that contain super-cooled liquid water for glaciation. Cirrus clouds are seeded at lower latitudes to reduce the average temperature of the planet, whereas this invention targets polar clouds to restore ice in polar regions. Cirrus clouds have little effect on the Arctic radiation budget, whereas low-level, mixed-phase clouds have a profound effect on the Arctic radiation budget.⁹

### BRIEF DESCRIPTION OF DRAWINGS

FIG. 1: Cross section of a mixed-phase cloud (left) that absorbs LW surface radiation and re-emits a fraction of the absorbed radiation back to the surface. The cloud is glaciated by some process (hatched arrow) to create an ice-only cloud (right) that allows radiation formerly re-emitted to the surface to be transmitted through the cloud.

FIG. 2: Schematic of seeding a mixed-phase cloud by dropping dry ice pellets from an aircraft above the cloud.

FIG. 3: Schematic of seeding a mixed-phase cloud by spraying an instantaneous line source of ice crystals into the top of the cloud with effervescent nozzles, or alternatively by injecting silver iodide into the cloud.

FIG. 4: (a) Diameter of a dry ice pellet versus the distance fallen after release from an aircraft above the cloud. (b) Percentage of mass lost by a falling dry ice pellet in 20 m intervals along the path of descent.

FIG. 5: Cross section of a 400 m thick cloud normal to the direction of the aircraft showing the INP concentration 4 days after seeding.

FIG. 6: INP concentration from FIG. 5 at a position 200 m beneath the top of the cloud.

### DETAILED DESCRIPTION

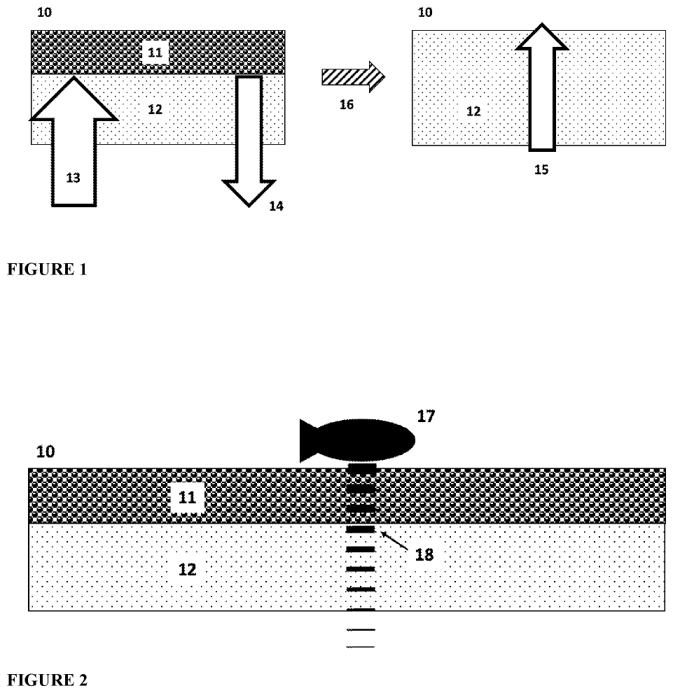

Arctic sea ice is extremely sensitive to LW radiative forcing,¹⁰ and low-level stratus or stratocumulus mixed-phase clouds have a profound effect on the Arctic radiation budget. Mixed-phase clouds containing liquid water increase the LW forcing roughly 40 W m⁻² over clear skies or ice-only clouds,^{9,11} warming the Arctic surface by about 13° C. during the winter.¹² Glaciation of mixed-phase clouds during the winter would enhance the growth of sea ice, increasing the ice coverage of the Arctic Ocean in the summer months so that more SW radiation reflects off the ice into space instead of heating the Arctic Ocean. FIG. 1 shows a cross section schematic of a polar mixed-phase cloud (10) in the winter with liquid droplet layer (11) near the top of the cloud and a much more diffuse layer of ice crystals (12) in the lower part of the cloud. Surface LW radiation (13) is absorbed by the cloud because the liquid droplet layer acts as a blackbody absorber for LW radiation. The cloud emits roughly 40 W m⁻² of LW radiation (14) back to the surface relative to clear-sky or ice-only cloud conditions, thereby warming the surface. The hatched arrow (16) represents a process such as cloud seeding that glaciates cloud (10) into an ice-only cloud that effectively transmits an extra 40 W m⁻² of LW radiation (15) to higher, colder regions of the atmosphere or into space, allowing the surface to cool. Within a few days the mixed-phase cloud will likely reform so that it is necessary to re-apply process (16) to the same region at regular intervals.

A reduction in LW radiative forcing ΔF^{↑} applied over a time period t would increase the sea ice thickness by approximately Δh=F^{↑}t/(ρL), where L=333.4 kJ kg⁻¹ is the latent heat of fusion of seawater and ρ=917 kg m⁻³ is the density of sea ice.¹³ This simple estimate predicts that 1 W m⁻² of reduced forcing over 1 month will thicken the sea ice by 0.85 cm. Lui and Key present evidence that September Arctic sea ice coverage increased 48% between 2012 and 2013 due to a 20% reduction in cloud coverage during January and February of 2013.¹³

One embodiment of (16) is to seed the clouds by releasing pellets of dry ice just above the tops of the clouds by aircraft. As dry ice pellets fall and sublimate they leave behind dense trails of ice crystals from homogeneous condensation freezing of water vapor. The release of dry ice pellets creates a curtain of ice crystals that diffuses laterally over time, glaciating the cloud by the Wegener-Bergeron-Findeisen (WBF) process, where water vapor from liquid droplets transfers to the growing ice crystals because the saturation vapor pressure of liquid water is greater than the saturation vapor pressure of ice. This embodiment is shown schematically in FIG. 2 where aircraft (17) releases dry ice pellets (18) into mixed-phase cloud (10) to glaciate the liquid droplet layer (11) near the top of the cloud. Ice pellets (18) are assumed to decrease in diameter as they sublimate but not in length; this assumption is used in the sublimation calculation of Kochtubajda and Lozowski.¹⁴ The falling pellets create a curtain of ice crystals in the plane of FIG. 2 that diffuses laterally through the cloud.

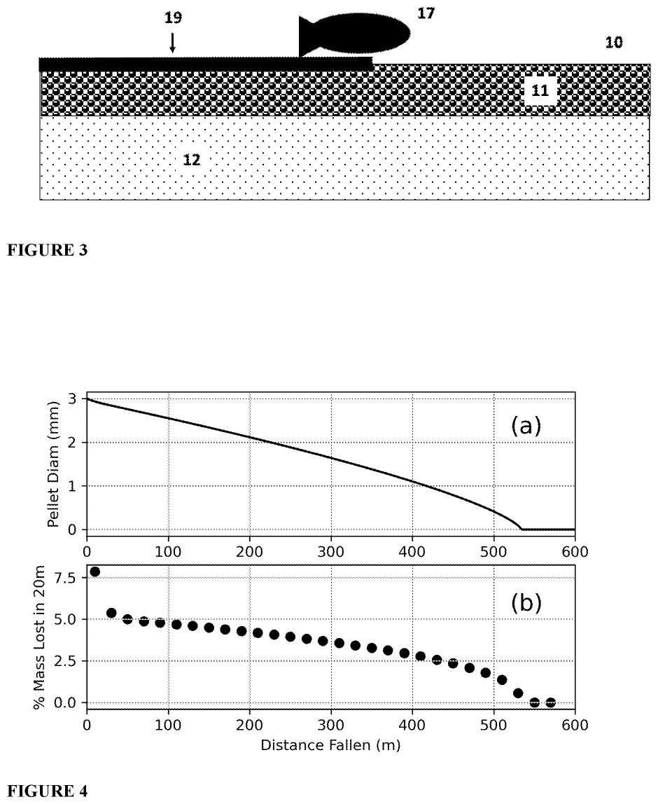

A second embodiment of process (16) is to use high pressure effervescent nozzles to spray a mixture of air and water into the top of the clouds by aircraft. As the air expands adiabatically at the nozzle exit it freezes water droplets from the nozzle into ice crystals so that the nozzles create an instantaneous line source of ice crystals near the tops of the clouds that diffuses through the clouds. This embodiment is shown schematically in FIG. 3, where aircraft (17) sprays a line source of ice crystals (19) into the top of cloud (10) to glaciate the liquid drop layer (11).

A third embodiment of process (16) is to seed the clouds using silver iodide (AgI), the seeding agent most frequently used to enhance precipitation at lower latitudes. AgI has the advantage that it does not sublimate and may be injected into the clouds from the ground as well as from the air. The injection of AgI from the air is also illustrated schematically in FIG. 3, where aircraft (17) injects a line source of AgI particles (19) into the top of cloud (10). However, AgI might react with ozone in the atmosphere to create iodic acid, a potent source of cloud condensation nuclei (CCN) that might potentially enhance the formation of the liquid droplet layer (11).¹⁵ Hence it may be preferable to consider one of the previous two embodiments for process (16) rather than injection of AgI.

An exemplary embodiment of the invention was simulated where low-level mixed-phase clouds over the Arctic Ocean are seeded by dropping dry ice pellets immediately above the clouds from aircraft in order to accelerate the growth of sea ice during the Arctic winter months of November through February. During the fall, winter, and spring the Arctic albedo is high and the zenith angle is high so that mixed-phase clouds exert a net warming effect on the Arctic surface, trapping more LW radiation and reflecting less SW radiation.⁹ The super-cooled liquid droplet layer in the top part of the cloud is effectively a black body absorber if the liquid water profile (LWP) exceeds 30 g m⁻²,¹⁶ hence all clouds with LWP>30 g m⁻² have essentially the same influence on the radiation budget. Clouds with a lower LWP require less dry ice for glaciation to achieve the same radiative effect so that it is most economical to seed during the Arctic winter months of November through February when the clouds contain more ice and less liquid water. The average mixed-phase cloud coverage during November through February is estimated to be 36% based on measurements reported by Intrieri et al. at one Arctic location (the SHEBA experiment).¹⁷

The simulation assumes 400 m thick stratus clouds. Aircraft fly along parallel tracks spaced by 4 km immediately above the clouds and release 1 kg km⁻¹ of dry ice pellets. The dry ice pellets are cylindrical pieces 3 mm in diameter with an average length of 1 cm. FIG. 4a plots a simulation of the diameter of the pellet versus distance fallen based on the sublimation relation of Kochtubajda and Lozowski.¹⁴ According to the simulation, 86.5% of the pellet mass sublimates in the saturated environment of the cloud before the pellet falls below the base of the cloud. All ice crystals generated below the base of the cloud are assumed to sublimate immediately. FIG. 4b divides the path of descent into 20 m segments and plots the fraction of the pellet that sublimates in each segment. From this figure it is evident that the pellet sublimates more rapidly in the liquid droplet region of the cloud at earlier times during its descent. One kg of falling pellets can generate 5×10¹⁴ ice crystals.¹⁸

The falling pellets create a curtain of ice crystal within the cloud containing 5×10¹⁴ ice crystals km⁻¹ along the track of the aircraft. A coordinate system is chosen where the aircraft flies along the positive y-axis, the x-axis points up, and the z-axis points along the top of the clouds normal to the flight direction. The dry ice pellets are released by the aircraft at (x, z)=(0,0) and create an instantaneous planar source of ice crystals in the x-y plane. These ice crystals glaciate the cloud by the WBF process as they diffuse in the z-direction through the cloud. The ice crystal concentration in the cloud versus time is modeled by numerically solving the 2-dimensional diffusion equation in the x-z plane normal to the flight direction. Immediately above the cloud top at x>0 the air is typically saturated¹⁹ so that Neumann boundary conditions (zero derivative of the ice crystal concentration) are applied at the top of the cloud. Neumann boundary conditions are also applied at z=±2 km on either side of the track because identical tracks are present at z=±4 km. A Dirichlet boundary condition of zero is applied at the base of the cloud at x=−0.4 km (zero ice crystal concentration) because any ice crystals that diffuse into the unsaturated air below the base of the cloud are assumed to sublimate immediately.

Cloud top cooling due to thermal emission from the liquid droplet layer creates turbulence within the cloud that is modeled with an effective eddy diffusion coefficient D₀. Smith et al. provide D₀=4.4 m² s⁻¹ for liquid stratus clouds²⁰; this value is assumed here for mixed-phase clouds. Within the glaciated region most of the cloud top radiative cooling ceases so that the turbulence within the cloud greatly decreases. This effect enhances the lateral diffusion of the ice crystals relative to their vertical diffusion. To model this effect, D₀ was reduced by a factor of 10 for the entire depth of the cloud after the ice crystal concentration C(x=0, z) at the top of the cloud exceeded 10⁴ m⁻³, or 100 times the natural INP concentration. The liquid droplet layer is assumed to glaciate at this INP concentration.²¹ D(z)is adjusted linearly for lower ice crystal concentrations according to the prescription:

$$D ( z ) = {D}_{0} - \frac{( {D}_{0} - {D}_{0} / 10 ) C ( 0 , z )}{1 {0}^{4}}$$

The factor of 10 reduction in D within the glaciated region is rather arbitrary because the eddy diffusion coefficient for a glaciated cloud is not known. It is expected to be much smaller than for an unglaciated cloud, however not zero because the high density of ice crystals after seeding will also emit LW radiation and create some residual cooling of the cloud.

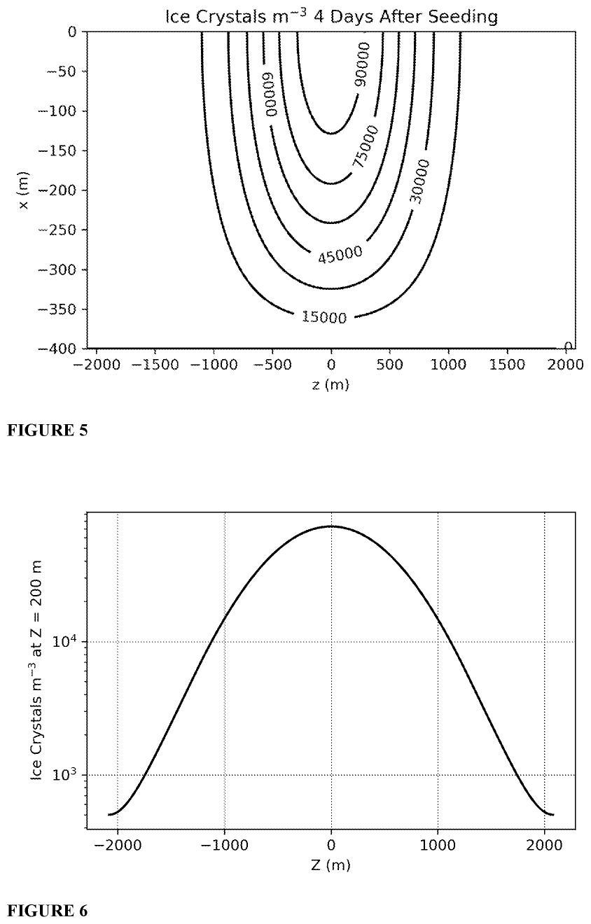

FIG. 5 shows a contour plot of the ice crystal concentration in the cloud 4 days after seeding. FIG. 6 shows the concentration at a depth of 200 m into the cloud. 56% of the cloud has an ice crystal concentration greater than 10⁴ m⁻³ and is assumed to be glaciated. After 4 days the same region is reseeded, however the tracks are offset by 2 km in the z-direction so that the positions with the lowest ice crystal concentration shown in FIGS. 5 and 6 are seeded on subsequent passes.

While the invention has been described with reference to some specific embodiments, it will be understood by those skilled in the art that changes may be made and equivalents may be substituted while remaining within the scope of the invention. Therefore, it is intended that the invention not be limited to the particular embodiments discussed, but that the invention will include any embodiment falling within the scope of the appended claims.

### APPENDIX: NONPATENT LITERATURE

1. J. A. Francis, S. J. Vavrus (2012). Evidence linking Arctic amplification to extreme weather in mid-latitudes. Geophys. Res. Lett. 39, L06801.
2. J. Intrieri et al. (2002). An annual cycle of Arctic cloud forcing at SHEBA. J. Geophys. Res. Oceans, 107, doi.org/10.1029/2000JC000439.
3. W. R. Lee, D. G. MacMartin, D. Visioni, B. Kravitz (2021). High-latitude stratospheric aerosol geoengineering can be more effective if injection is limited to spring. Geophys. Res. Lett., 48, e2021GL092696.
4. S. J. Desch et al. (2016). Arctic ice management. Earth's Future, 5 (1), p. 107.
5. L. Field et al. (2018). Increasing Arctic sea ice albedo using localized reversible geoengineering. Earth's Future, 6, p. 882.
6. J. Latham et al. (2008). Global temperature stabilization via controlled albedo enhancement of low-level maritime clouds. Phil. Trans. R. Soc. A., 372 (1882), 3969-87.
7. B. Kravitz et al. (2014). Process-model simulations of cloud albedo enhancement by aerosols in the Arctic. Phil. Trans. R. Soc. A., 372, 20140052.
8. D. L. Mitchell, W. Finnegan (2009). Modification of cirrus clouds to reduce global warming. Environ. Res. Lett., 4, 045102 (8 pp), doi:10.1088/1748-9326/4/4/045102.
9. M. D. Shupe, J. M. Intrieri (2004). Cloud radiative forcing of the Arctic surface: the influence of cloud properties, surface albedo, and solar zenith angle. J. Clim., 17, p. 616.
10. E. E. Ebert, J. A. Curry (1993). An intermediate one-dimensional thermodynamic sea ice model for investigating ice-atmosphere interactions. J. Geophys. Res., 98, 10,085-10,109.
11. H. Morrison, et al. (2012). Resilience of persistent Arctic mixed-phase clouds. Nat. Geosci., 5, 11.
12. K. Stramler, A. D. Del Genio, W. B. Rossow (2011). Synoptically driven Arctic winter states. J. Clim., 24, p. 1747.
13. Y. Lui, J. R. Key (2014). Less winter cloud aids summer 2013 Arctic sea ice return from 2012 minimum. Environ. Res. Lett., 9, 044002.
14. B. Kochtubajda, E. P. Lozowski (1985). The sublimation of dry ice pellets used for cloud seeding. J. Clim. Appl. Meteorol., 24, 597-605.
15. A. Baccarini et al. (2020). Frequent new particle formation over the high Arctic pack ice by enhanced iodine emissions. Nat. Commun., 11 (1), doi: 10.1038/s41467-020-18551-0.
16. G. L. Stephens (1978). Radiation profiles in extended water clouds. II: Parameterization schemes. J. Atmos. Sci., 35, 2132.
17. J. Intrieri, et al. (2002). An annual cycle of Arctic cloud characteristics observed by radar and lidar at SHEBA. J. Geophys. Res., 107, doi.org/10.1029/2000JC000423.
18. A. S. Dennis (1980). Weather Modification by Cloud Seeding. International Geophysics Series, 24.
19. S. Qiu, Dong, B. Xi, J.-L. F. Li (2015). Characterizing Arctic mixed-phase cloud structure and its relationship with humidity and temperature inversion using ARM NSA observations. J. Geophys. Res. Atmos., 120, 7737-7746.
20. T. B. Smith, C.-W. Chien, P. B. MacCready, Jr. (1968). Study of the engineering of cloud seeding. MRI68 FR-817, Meteorology Research, Inc., Altadena, California.
21. K. Loewe, thesis, Karlsruher Institut für Technologie (2017).

1. A method for restoring terrestrial ice or sea ice at high latitudes, the method comprising seeding mixed-phase clouds during the fall, winter, and spring to convert supercooled liquid droplets within the clouds into ice crystals, thereby allowing surface long wavelength radiation to be transmitted through ice-only clouds or through clear skies without being absorbed by mixed-phase clouds and re-emitted to the surface, whereby the surface temperature is reduced.

2. The method of claim 1, wherein the seeding is performed by dropping pellets of dry ice into the clouds.

3. The method of claim 1, wherein the seeding is performed by spraying water droplets into the clouds using effervescent nozzles, whereby the sprayed water droplets freeze into ice crystals as the air expands at the exit of the nozzle.

4. The method of claim 1, wherein the seeding is performed by injecting silver iodide into the clouds.

5. The method of claim 2, wherein seeding is performed to prevent tundra from thawing.

6. The method of claim 2, wherein seeding is performed to enhance the growth of sea ice, whereby the surface area covered by sea ice is increased during the summer.

7. The method of claim 3, wherein seeding is performed to prevent tundra from thawing.

8. The method of claim 3, wherein seeding is performed to enhance the growth of sea ice, whereby the surface area covered by sea ice is increased during the summer.

9. The method of claim 4, wherein seeding is performed to prevent tundra from thawing.

10. The method of claim 4, wherein seeding is performed to enhance the growth of sea ice, whereby the surface area covered by sea ice is increased during the summer.
